(19) United States
(12) Patent Application Publication
(10) Pub. No.: US 2011/0262275 A1
(43) Pub. Date: Oct. 27, 2011

(54) METHOD FOR PRODUCING THRUST (EMBODIMENTS) AND APPARATUS FOR TRAVEL IN A FLUID MEDIUM

(76) Inventors: Valeriy Adamovich Kovalchuk, Chelyabinsk (RU); Sergey Adamovich Xovalchuk, Chelyabinsk (RU); Roman Petrovich Bodrov, Chelyabinsk (RU)

(21) Appl. No.: 13/060,431

(22) PCT Filed: Aug. 25, 2009
(86) PCT No.: PCT/RU2009/000426

§ 371 Date: Jul. 11, 2011

(30) Foreign Application Priority Data
Aug. 25, 2008 (RU) 2008134763

(51) Int. Cl. B64C 21/00; B63H 11/00

(52) U.S. Cl. 416/20 R

(57) ABSTRACT

The subject of the patent is a group of inventions relating to an apparatus for movement in air and water. The apparatus for movement in fluid comprises an aerodynamic cross-section wing with a convex upper surface, and a source of high pressure fluid interconnected with a means for forming pressure jets over the convex upper surface of the wing. Six embodiments of the apparatus are characterized by the design of the means for forming pressure jets. The method for developing thrust consists of using the means for forming pressure jets over the convex upper surface of the wing. Five embodiments of the method are characterized by the design of the means for forming pressure jets. The group of inventions is aimed to increase efficiency.

### CROSS-REFERENCE TO RELATED APPLICATION

This application claims the benefit of the priority filing date in PCT/RU2009/000426 referenced in WIPO Publication WO2010/024726. The earliest priority date claimed is Aug. 25, 2008.

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention relates to the field of transportation technology, namely to methods for developing thrust and an apparatus with an aerodynamic cross-section wing, which can be used for movement in fluid, air and water.

Currently, the following types of propulsion devices are used for developing thrust in gas (air) and liquid (water) media:
vessels with average density lower than the density of the environment, e.g., airships, balloons, and submarine vessels. Such propulsion devices can only develop vertical thrust (according to the Archimedes law);
jet engines based on exhaust of stored working medium or on intake, acceleration and subsequent exhaust of the environmental material (according to the Newton law);
fans (marine propellers) based on the interaction of an inclined plane and the environment during their relative motion;
aircraft wings (helicopter rotors) based on the effect of reducing pressure in a medium when the speed of medium movement determined by the wing geometry increases. To achieve reduced pressure under an aircraft wing or a helicopter rotor, it is necessary to make an aircraft or a helicopter move relative to air (lift can also be generated by wind, but this would not be a controlled flight).

The closest analogue (prototype) is a method for developing thrust and a vertical takeoff and landing aircraft (a flying saucer) per RF patent No. 2151717 of 03.02.1998 published 06.27.2000. This method for developing thrust is characterized by the direction of pressure jets of fluid (air flow) over (along a tangent) the upper convex surface of an aerodynamic cross-section wing (disk) for intensive airflow over the disk's upper surface.

The method for developing thrust used in the invention (the Coanda effect) is characterized by the fact that uniform air flow is created along the tangent to an aerodynamic cross-section wing (a disk with a spherical upper surface), and blowing over the wing's upper surface. According to the Bernoulli law, a rarefied space is created and vertical upward thrust is developed. Herein, a high pressure fan is installed above the wing's upper surface. The fan comprises two centrifugal rotors mirroring each other and rotating coaxially in opposite directions. In addition, the fan has a diffuser in the form of an annular choke with a helical channel for changing the thrust vector and turning it on in the mode of translational motion of the plate. Because weight gain caused by the suction effect is insignificant, the method and apparatus have low efficiency of developing thrust.

The technical objective of the claimed solutions is to increase the efficiency of developing thrust.

The stated objective is achieved by a group of inventions united by a common inventive concept. The group comprises:
a method for developing thrust consisting in directing pressure jets of fluid from nozzles along a tangent to the convex upper surface of an aerodynamic cross-section wing, wherein, according to the invention, the nozzles are moved at an angle in the direction of the pressure jets of fluid that capture surrounding fluid by means of vortices;
an apparatus for movement in fluid comprising an aerodynamic cross-section wing with a convex upper surface and a source of high pressure fluid interconnected with a means for forming pressure jets from nozzles directed along a tangent to the convex upper surface of the wing, wherein, according to the invention, it has a drive for rotating the nozzles of said means, the means is made in the form of a hollow axle rotor coaxial with the wing's longitudinal axis, capable of forming pressure jets with vortices;
a method for developing thrust that consists in directing pressure jets of fluid from nozzles along a tangent to the convex upper surface of an aerodynamic cross-section wing, wherein, according to the invention, the points of exhaust of pressure jets of the fluid that capture surrounding fluid by means of vortices are changed sequentially;
an apparatus for movement in fluid comprising an aerodynamic cross-section wing with a convex upper surface and a source of high pressure fluid interconnected with a means for forming pressure jets from nozzles directed along a tangent to the convex upper surface of the wing, wherein, according to the invention, said means is made in the form of a bank of stationary nozzles that are connected to a pulsating air breathing engine and which simulate circular movement of the nozzles and capable of forming pressure jets with vortices;
a method for developing thrust that consists in directing pressure jets of fluid from nozzles over the convex upper surface of an aerodynamic cross-section wing, wherein, according to the invention, the nozzles are set to reciprocating movement in the wing's longitudinal axis plane so that the pressure jets of fluid capture surrounding fluid by means of vortices;
an apparatus for movement in fluid comprising an aerodynamic cross-section wing with a convex upper surface and a source of high pressure fluid interconnected with a means for forming pressure jets directed along a tangent to the convex upper surface of the wing, wherein, according to the invention, the means for forming pressure jets is made in the form of a bank with a hollow axle and nozzles that are installed in the wing's longitudinal axis plane, with the nozzles being capable of forming pressure jets with vortices and connected to a reciprocating motion mechanism;
an apparatus for movement in fluid comprising an aerodynamic cross-section wing with a convex upper surface and a means for forming pressure jets over the convex upper surface of the wing, wherein, according to the invention, the means for forming pressure jets is made in the form of hinge-mounted curved nozzles connected to a pulsating air breathing engine, capable of forming pressure jets with vortices and resetting by means of springs;
a method for developing thrust that consists in directing pressure jets of fluid over the convex upper surface of an aerodynamic cross-section wing, wherein, according to the invention, the point of reciprocating exhaust from nozzles of pressure jets of fluid that capture surrounding fluid by means of vortices is simulated in the wing's longitudinal axis plane;
an apparatus for movement in fluid comprising an aerodynamic cross-section wing with a convex upper surface and a means with nozzles for forming pressure jets over the convex upper surface of the wing, wherein, according to the invention, the means for forming pressure jets is made in the form of a bank of stationary nozzles installed in the wing's longitudinal axis plane and connected to a pulsating air breathing engine capable of reciprocating change in the point of exhaust from the nozzles of pressure jets of fluid that capture surrounding fluid by means of vortices;
a method for developing thrust that consists in directing pressure jets of fluid from nozzles over the convex upper surface of an aerodynamic cross-section wing, wherein, according to the invention, the nozzles of pressure jets of fluid are set to oscillating movement in the plane parallel to the longitudinal axis of said wing so that the pressure jets of fluid capture surrounding fluid by means of vortices;
an apparatus for movement in fluid comprising an aerodynamic cross-section wing with a convex upper surface and a means for forming pressure jets and directing them over the convex upper surface of the wing, wherein, according to the invention, the means for forming pressure jets is made in the form of a rotor that is installed perpendicularly to the wing's longitudinal axis and has a hollow axle and nozzles installed symmetrically on the axle end face at an angle to the end face, with the pressure jets being capable of capturing surrounding fluid by means of vortices.

The invention is based on the phenomenon, discovered by the author V. A. Kovalchuk, of reduction of pressure in the area of movement of jets that form when the jet source moves at an angle in the direction of the jet. The author has called such jet exhaust a “spread jet” (FIG. 1). A “spread jet” is formed both when the jet source is moving and when the point of jet exhaust changes sequentially, i.e., during “imaginary” movement of the source.

The proposed methods for developing thrust make it possible to form helical spread jets, after the nozzles, with low pressure inside which, in centrifugal movement toward the wing perimeter, draw (capture and carry away) into vortex motion a large volume of surrounding fluid, substantially reducing the pressure under the wing (without wing movement in the medium). Thus, thrust efficiency increases, making it possible to get high motion speeds.

During exhaust of the jets and simultaneous rotation of the rotor with nozzles, and reciprocating or oscillating movement of the nozzles in the “spread jet” area, a system of infinite vortex jets moving from the nozzles to the peripheral area of the wing is generated. The vortices have a much higher energy potential than jets of fluid, and during movement, vortex strings capture and carry away large masses (amount) of ambient air resulting in reducing the air pressure under the wing. The pressure differential above and under the wing results in movement of the apparatus.

Because the apparatus has no mechanical elements acting on the medium, it simplifies the apparatus' design and results in reducing its dimensions and increasing its reliability, which makes it possible to perform takeoff and landing in any direction without risking damage in the case of contact with surrounding objects.

Patent research reveals no identical technical solutions, which infers novelty and a level of technicality of the claimed technical solutions.

The domestic industry has all necessary means (materials, technology and equipment) for the manufacture and widespread multifunctional implementation of the proposed apparatus.

### SUMMARY OF THE INVENTION

The subject of the patent is a group of inventions relating to an apparatus for movement in air and water. The apparatus for movement in fluid comprises an aerodynamic cross-section wing with a convex upper surface, and a source of high pressure fluid interconnected with a means for forming pressure jets over the convex upper surface of the wing. Six embodiments of the apparatus are characterized by the design of the means for forming pressure jets. The method for developing thrust consists of using the means for forming pressure jets over the convex upper surface of the wing. Five embodiments of the method are characterized by the design of the means for forming pressure jets. The group of inventions is aimed to increase efficiency.

### BRIEF DESCRIPTION OF THE DRAWINGS

The essence of the inventions is explained in the drawings where:

FIG. 1 is a schematic view of the formation of “spread” jets;

FIG. 2 is a schematic view of the formation of vortices (top view);

FIG. 3 is a schematic view of the formation of vortices (longitudinal cross-section);

FIG. 4 is a general view of the means for forming vortices (with a rotor and radial arrangements of the nozzles);

FIG. 5 is a general view of the means for forming vortex jets (with a rotor and nozzles arranged at an angle);

FIG. 6 is a general view of the apparatus with a bank of stationary nozzles that simulate a circular motion of the nozzles;

FIG. 7 is a general view of the means for forming vortices (with reciprocating movement of the nozzles);

FIG. 8 is a general view of the means for forming vortices (with imitation of the reciprocating movement of the nozzles);

FIG. 9 is a general view of the means for forming vortices (with reciprocating movement of curved nozzles with a spring);

FIG. 10 is a general view of the means for forming vortices (with oscillating movement of the nozzles tilted toward the rotor end face);

FIG. 11 is a general view of a wing in the shape of a spherical segment;

FIG. 12 is a general view of a wing in the shape of a spherical segment with a hole in its center;

FIG. 13 is a schematic diagram of the direction of pressure jets when a wing is made in the shape of a spherical segment with a hole in its center;

FIG. 14 is a general view of a wing in the shape of two spherical segments;

FIG. 15 is a general view of the apparatus with a wing in the shape of a curved rectangular plate (with an arched bend of its cross-section); and

FIG. 16 is a general view of the apparatus with a wing in the shape of a curved triangular plate (with an arched bend of its cross-section).

### DESCRIPTION OF PREFERRED EMBODIMENTS

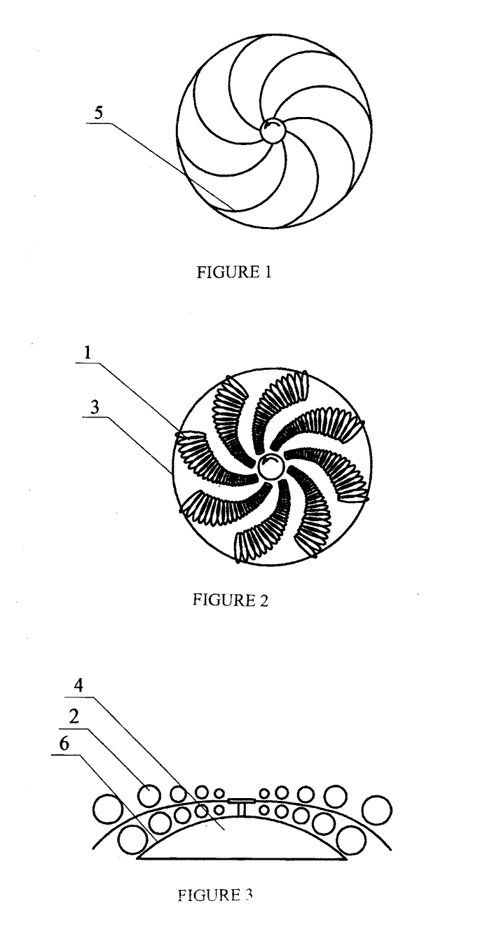

The proposed inventions use a unique feature of gas vortices 1 during their movement to pull in (annex) very large masses of surrounding fluid 2 (FIGS. 2 and 3) which is caused by the presence of rarefied space in the central area of the vortex 1. When the vortices 1 move from the center to the edge 3 of the wing 4, large air masses 2 are captured and carried away which results in a reduction of pressure under the wing 4. The effect of developing thrust takes place when the source of the pressure jet 5 moves in one direction (circularly), as well as when movement in the plane of the longitudinal axis of the wing 4 reciprocates and when movement in the plane parallel to the longitudinal axis of the wing 4 oscillates.

The method for developing thrust per claim 1 consists in directing fluid pressure jets 5 from the nozzles along a tangent to the convex upper surface 6 of the aerodynamic cross-section wing 4, wherein the nozzles 7 are moved at an angle relative to the direction of the fluid pressure jets 5 which capture surrounding fluid by means of vortices 1.

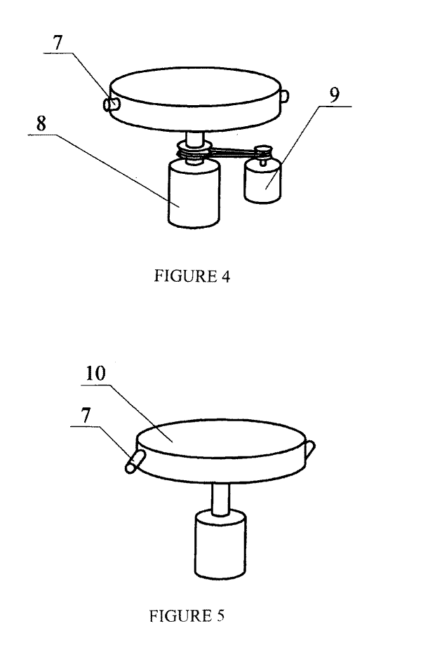

The apparatus per claim 2, and with movement as per the method proposed above, comprises an aerodynamic cross-section wing 4 with a convex upper surface 6 and a source 8 of high pressure fluid interconnected with a means for forming pressure jets 5 from the nozzles 7 directed along a tangent to the convex upper surface 6 of the wing 4; the source 8 has a drive for rotating the nozzles 7 made in the form of a rotor 9 installed coaxially with the wing's longitudinal axis, with a drive 10 and a hollow axle (not shown), and which is capable of forming pressure jets 5 with vortices 1 (FIG. 4 and FIG. 5).

The source 8 of high pressure fluid is made in the form of a (centrifugal or axial) compressor.

The method for developing thrust as per claim 3 consists in directing fluid pressure jets 5 from the nozzles 7 along a tangent to the convex upper surface 6 of the aerodynamic cross-section wing and, in doing this, sequentially changing the points of exhaust of fluid pressure jets 5 that capture surrounding fluid by means of vortices 1.

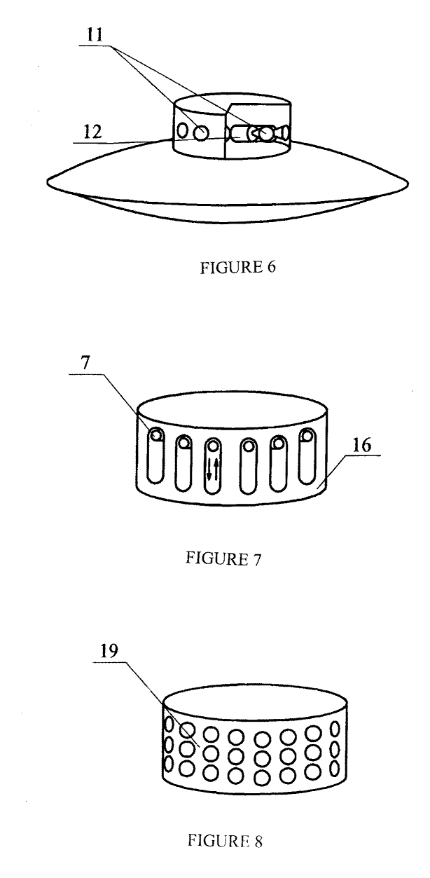

The apparatus as per claim 4, for movement in fluid as per the method proposed in claim 3, comprises an aerodynamic cross-section wing 4 with a convex upper surface 6 and a source of high pressure fluid interconnected with a means for forming pressure jets 5 from the nozzles directed along a tangent to the convex upper surface 6 of the wing 4. Said means for forming pressure jets 5 is made in the form of a bank of stationary nozzles 11 which are connected to a pulsating air breathing engine 12 and which simulate a circular movement of the nozzles, and capable of forming pressure jets 5 with vortices 1 (FIG. 6).

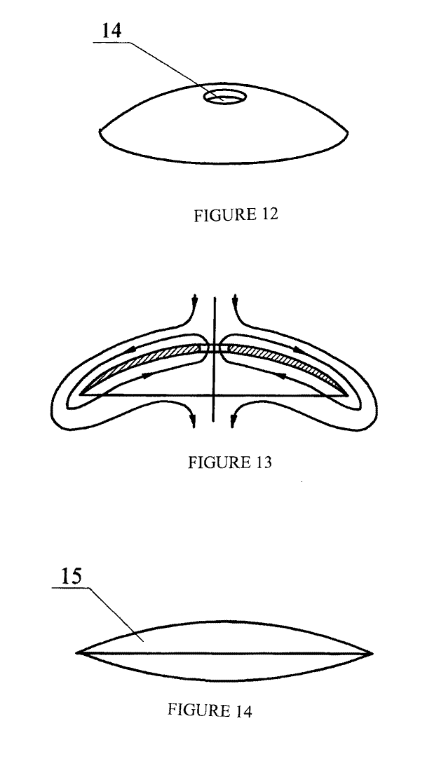

In the apparatus as per claims 2 and 4, an aerodynamic cross-section wing 4 can be made as a plate in the form of a spherical segment 13 (FIG. 11), a spherical segment 13 with a hole 14 in the center (FIG. 12 and FIG. 13), or two spherical segments 15 (FIG. 14).

The method for developing thrust as per claim 5 consists in directing fluid pressure jets 5 from the nozzles 7 over the convex upper surface 6 of an aerodynamic cross-section wing 4, while the nozzles 7 are set to reciprocating movement in the plane of the longitudinal axis of the wing 4 so that fluid pressure jets 5 capture surrounding fluid by means of vortices 1.

The apparatus as per claim 6, for movement in fluid as per the method proposed in claim 5, comprises an aerodynamic cross-section wing 4 with a convex upper surface 6 and a source 8 of high pressure fluid interconnected with a means for forming pressure jets 5 above the convex upper surface of the wing 4, wherein said means for forming pressure jets 5 is made in the form of a bank 16 with a hollow axle (not shown) and nozzles 7. The bank 16 is installed in the plane of the longitudinal axis of the wing 4, and the nozzles are capable of forming pressure jets 5 with vortices 1 and are connected to a reciprocating motion mechanism (not shown) (FIG. 7).

The source 8 of high pressure fluid is made in the form of a (centrifugal or axial) compressor.

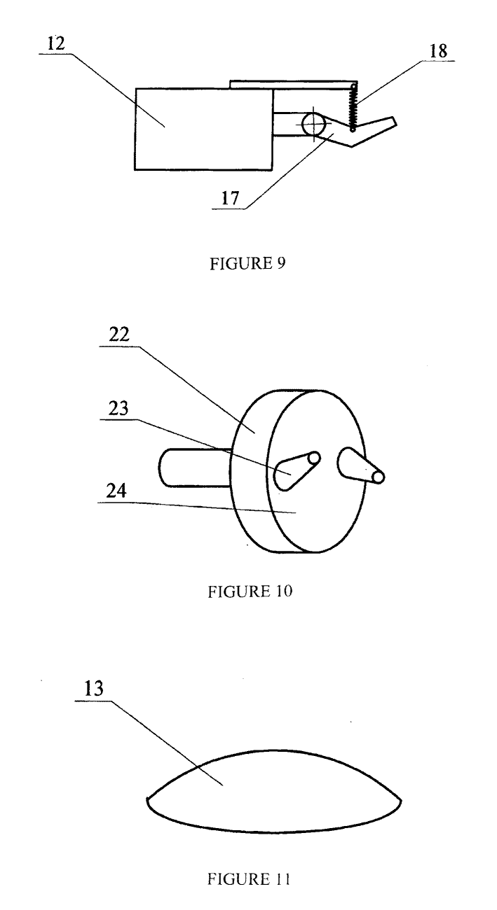

The apparatus as per claim 7, for movement in fluid as per the method proposed in claim 5, comprises an aerodynamic cross-section wing 4 with a convex upper surface 6, a means with nozzles for forming pressure jets over the convex upper surface 6 of the wing 4, wherein said means for forming pressure jets 5 is made in the form of curved nozzles 17 that are hinge-mounted, connected to a pulsating air breathing engine 12, and capable of forming pressure jets 5 with vortices 1 and reseting by means of springs 18 (FIG. 9).

The method for developing thrust as per claim 8 consists in directing fluid pressure jets 5 from the nozzles 7 over the convex upper surface 6 of the aerodynamic cross-section wing, while simulating, in the wing's longitudinal axis plane, the point of reciprocating exhaust from the nozzles 7 of fluid pressure jets 5 that capture surrounding fluid by means of vortices 1.

The apparatus as per claim 9, for movement in fluid as per the method proposed in claim 8, comprises an aerodynamic cross-section wing 4 with a convex upper surface 6, and a means for forming pressure jets 5 over the convex upper surface 6 of the wing 4, wherein said means for forming pressure jets 5 is made in the form of a bank 19 of stationary nozzles installed in the plane of the longitudinal axis of the wing 4, the bank connected to a pulsating air breathing engine 12 capable of reciprocatingly changing the point of exhaust from the nozzles of fluid pressure jets that capture surrounding fluid by means of vortices 1 (FIG. 8).

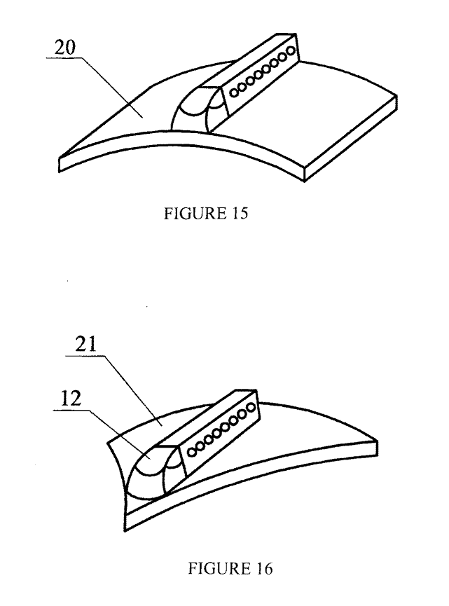

In the apparatus as per claim 9, an aerodynamic cross-section wing 4 can be made in the shape of a curved rectangular plate 20 with a cross-section in the form of an arc (FIG. 15) or in the shape of a triangular plate 21 with an arched bending of its cross-section (FIG. 16). In addition, it is possible to make the wing in the shape of a spherical segment 13 (FIG. 11), a spherical segment with a hole 14 in the center (FIGS. 12 and 13), or in the form of two spherical segments 15 (FIG. 14).

The method for developing thrust as per claim 10 consists in directing fluid pressure jets 5 from nozzles over the convex upper surface 6 of an aerodynamic cross-section wing 4, wherein the nozzles of fluid pressure jets 5 are set to oscillating movement in the plane parallel to the longitudinal axis of said wing 4 so that the fluid pressure jets 5 capture surrounding fluid by means of vortices 1.

The apparatus as per claim 11, for movement in fluid as per the method proposed in claim 10, comprises an aerodynamic cross-section wing 4 with a convex upper surface 6 and a source 8 of high pressure fluid interconnected with a means for forming and directing pressure jets over the convex upper surface 6 of the wing 4, wherein said means for forming pressure jets is made in the form of a rotor 22 with a hollow axle (not shown) and nozzles 23 installed perpendicularly to the wing's longitudinal axis, symmetrically, on an end face 24 at an angle to the end face 24, and capable of capturing the surrounding fluid with pressure jets 5 by means of vortices 1 (FIG. 10).

The source 8 of high pressure fluid is made in the form of a (centrifugal or axial) compressor, while the wing can have any of the above shapes.

The apparatus for movement in fluid work as follows.

Apparatus as per claim 2 (FIG. 4). A high pressure source 8 and a rotor 10 with nozzles 7 are turned on. Fluid (air or water) pressure jets 5 flow to the nozzles 7 of the apparatus. As a result, pressure jets 5 with vortices 1 are formed after the movable nozzles.

Apparatus as per claim 6 (FIG. 7). A high pressure source 8 and a mechanism of reciprocating movement of the nozzles (not shown) are turned on. Fluid (air or water) pressure jets 5 flow to the nozzles 7 of the apparatus. As a result, pressure jets 5 with vortices 1 are formed after the movable nozzles.

The apparatus per claim 11 (FIG. 10). A high pressure source 8 interconnected with inclined nozzles installed symmetrically on the end face of a rotor 24 is turned on. As they exhaust from the nozzles, pressure jets cause rotation of the rotor 22, while the nozzles 23 oscillate with respect to the wing 4. As a result, pressure jets 5 with vortices 1 are formed after the movable nozzles.

The apparatus as per claim 4 (FIG. 6) which, during simulated movement of the nozzles, works as follows: A pulsating air breathing engine 12 is turned on, and the jets that have been formed are fed under pressure in a set sequence to a bank 11 of stationary nozzles located on the bank's cylindrical surface. As a result, pressure jets 5 with vortices 1 are formed after the movable nozzles which simulate circular movement of the nozzles.

In the case of simulated reciprocating movement of nozzles, the apparatus per claim 9 (FIG. 8, FIG. 15 and FIG. 16) works as follows. The pulsating air breathing engine is turned on, and the pressure jets under pressure are fed to the bank 19 (FIG. 8) or banks (in FIG. 16 and FIG. 16) of stationary nozzles, located on the same line (linearly), where the point of exhaust of the pressure jets from the nozzles changes in a specified sequence. As a result, pressure jets 5 with vortices 1 are formed.

The apparatus per claim 7 (FIG. 9) works as follows. The pulsating air breathing engine 12 connected to the curved nozzles 17 is turned on and is able to reset by means of springs 18. As a result, the nozzles reciprocate which forms pressure jets 5 with vortices 1.

When vortices 1 move from the center to the edge 3 of the wing 4, large masses of air 2 are captured and carried away, causing a reduction of pressure under the wing 4. The apparatus (in any of the claimed embodiments) lifts, and moves in the required direction.

The author conducted tests of laboratory models of the apparatus with various wing shapes; the tests confirmed the apparatus' ability to develop thrust and move in any direction.

What is claimed is:

1. A method for developing thrust that consists of directing fluid pressure jets from nozzles along a tangent to the convex upper surface of an aerodynamic cross-section wing, distinctive in that the nozzles are moved at an angle in the direction of the fluid pressure jets which capture surrounding fluid by means of vortices.

2. An apparatus for movement in fluid comprising an aerodynamic cross-section wing with a convex upper surface and a source of high pressure fluid interconnected with a means for forming pressure jets from nozzles directed along a tangent to the convex upper surface of the wing, distinctive in that it has a drive for rotating the nozzles of said means, the means made in the form of a rotor with a hollow axle installed coaxially with the wing's longitudinal axis and capable of forming pressure jets with vortices.

3. A method for developing thrust that consists of directing fluid pressure jets from nozzles along a tangent to the convex upper surface of an aerodynamic cross-section wing, distinctive in that the points of exhaust of fluid pressure jets that capture surrounding fluid by means of vortices are changed sequentially.

4. An apparatus for movement in fluid comprising an aerodynamic cross-section wing with a convex upper surface and a source of high pressure fluid interconnected with a means for forming pressure jets from nozzles directed along a tangent to the convex upper surface of the wing, distinctive in that said means is made in the form of a bank of stationary nozzles that are connected to a pulsating air breathing engine and simulate circular movement of the nozzles with a capacity to form pressure jets with vortices.

5. A method for developing thrust that consists of directing fluid pressure jets from nozzles over the convex upper surface of an aerodynamic cross-section wing, distinctive in that the nozzles are set to reciprocating movement in the wing's longitudinal axis plane so that fluid pressure jets capture surrounding fluid by means of vortices.

6. An apparatus for movement in fluid comprising an aerodynamic cross-section wing with a convex upper surface and a source of high pressure fluid interconnected with a means for forming pressure jets from nozzles over the convex upper surface of the wing, distinctive in that the means for forming pressure jets is made in the form of a bank with a hollow axle and nozzles installed in the wing's longitudinal axis plane, the nozzles are made with the capacity to form pressure jets with vortices and connected to a reciprocating motion mechanism.

7. An apparatus for movement in fluid comprising an aerodynamic cross-section wing with a convex upper surface, and a means for forming pressure jets with nozzles over the convex upper surface of the wing, distinctive in that the means for forming pressure jets is made in the form of hinge-mounted curved nozzles connected to a pulsating air breathing engine and made with the capacity to form pressure jets with vortices and to reset by means of springs.

8. A method for developing thrust that consists in directing fluid pressure jets from nozzles over the convex upper surface of an aerodynamic cross-section wing, distinctive in that the point of reciprocating exhaust from the nozzles of fluid pressure jets that capture surrounding fluid by means of vortices is simulated in the wing's longitudinal axis plane.

9. An apparatus for movement in fluid comprising an aerodynamic cross-section wing with a convex upper surface and a means for forming pressure jets over the convex upper surface of the wing, distinctive in that the means for forming pressure jets is made in the form of a bank of stationary nozzles installed in the wing's longitudinal axis plane, and connected to a pulsating air breathing engine capable of reciprocating change of the point of exhaust from the nozzles of fluid pressure jets that entrap surrounding fluid by means of vortices.

10. A method for developing thrust that consists of directing fluid pressure jets from nozzles over the convex upper surface of an aerodynamic cross-section wing, distinctive in that the nozzles of fluid pressure jets are set to oscillating movement in the plane parallel to the longitudinal axis of said wing so that the fluid pressure jets capture surrounding fluid by means of vortices.

11. An apparatus for movement in fluid comprising an aerodynamic cross-section wing with a convex upper surface and a source of high pressure fluid interconnected with a means for forming pressure jets and directing them over the convex upper surface of the wing, distinctive in that the means for forming pressure jets is made in the form of a rotor with a hollow axle and nozzles installed perpendicular to the wing's longitudinal axis, the nozzles installed symmetrically on, and at an angle to, an end face with pressure jets capable of capturing surrounding fluid by means of vortices.
